(19) United States
(12) Patent Application Publication
(10) Pub. No.: US 2007/0098268 A1
(43) Pub. Date: May 3, 2007

(54) APPARATUS AND METHOD OF SHOT CLASSIFICATION

(75) Inventor: Ratna Beresford, Basingstoke (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/551,483

(22) Filed: Oct. 20, 2006

(30) Foreign Application Priority Data
Oct. 27, 2005 (GB) 0521948.0

(51) Int. Cl. G06K 9/62; H04N 5/44

(52) U.S. Cl. 382/224; 715/721

(57) ABSTRACT

A method of classifying a video shot comprises predicting an image from a preceding image using a parameter based image transform, and comparing points in the predicted image with corresponding points in a current image to generate an point error value for each point. These point error values are used to identify those points whose point error value exceeds a point error threshold. Then, for corresponding points on images used as input to subsequent calculations that update the image transform parameters, the points so identified are excluded from contributing to said calculations.

### BACKGROUND OF THE INVENTION

1. Field of the Invention

The present invention relates to apparatus and a method of video shot classification, and in particular to improving the robustness of video shot classification.

2. Description of the Prior Art Modem video editing and archival systems allow the storage and retrieval of large amounts of digitally stored video footage. In consequence, accessing relevant sections of this footage becomes increasingly arduous, and mechanisms to identify and locate specific footage are desirable.

In particular, in addition to the subject matter shown within the footage, it is frequently desirable to find a particular type of shot of that subject matter for appropriate insertion into an edited work.

Referring to FIG. 1, a number of video shots are possible depending upon the motion and/or actions of the camera with respect to the image plane 1. These include lateral movements such as booming, tracking and dollying, rotational movements such as panning, tilting and rolling, and lens movements such as zooming. When dollying and zooming are performed in the same axis they are almost indistinguishable, and the terms may generally be used interchangeably.

Thus, even within a particular subset of footage featuring the desired subject matter, searching for a particular shot can be particularly time-consuming. The problem may be further exacerbated when, for example, there are long periods of inaction as often occurs when observing wildlife, or the subject matter is covered by multiple cameras, or there are many separate shots of the subject matter currently on file.

Searches that are based upon camera metadata, which indicates functions enacted on the camera (such as a zoom) cannot offer a full solution; the majority of shots (including zooms) can be achieved by moving the camera as a whole rather than using camera functions. In addition, not all cameras and recording formats provide metadata, and large libraries of footage already exist without such data.

Thus it is desirable to provide a method and means to identify the type of shot by analysis of the footage alone.

EP-A-0509208 (IPIE) discloses a scheme for image analysis in which motion vectors are derived by comparing successive frames of an image sequence, and integrating the vectors over a number of frames until a threshold value is reached. This threshold for x or y components of the integrated vectors or a combination thereof can then be interpreted as overall horizontal or vertical panning. An integral of radial vector magnitude from a centre point is indicative of zoom. In this way, different video shots can be classified.

WO-A-0046695 (Philips) discloses a scheme for image analysis in which a translation function is derived for successive frames of a shot, and this translation function is subsequently analysed to determine whether it indicates panning, zooming or other types of shot.

However, neither scheme considers the common issue that the subject matter in the footage may comprise a locally moving object (such as an animal, car, or person). The object's motion within successive frames has the capacity to affect the motion vectors or translation function used within the shot analysis, resulting in a misclassification of shots.

Consequently, it is desirable to find an improved means and method by which to classify video shots in a more robust manner.

Accordingly, the present invention seeks to address, mitigate or alleviate the above problem.

### SUMMARY OF THE INVENTION

An object of the present invention is to provide an improved means and method by which to classify video shots in a more robust manner.

In a first aspect of the present invention, a method of classifying a video shot comprises predicting an image from a preceding image using a parameter based image transform, and comparing points in the predicted image with corresponding points in a current image to generate an point error value for each point, and these point error values are used to identify those points whose point error value exceeds a point error threshold; then, for corresponding points on images used as input to subsequent calculations that update the image transform parameters, the points so identified are excluded from contributing to said calculations.

By excluding image elements that do not appear to correspond with the global motion of the image, locally moving objects within the image are discounted from subsequent refinements of the image transform parameters used to model the global image motion. This improves the basis for shot classification by analysis of these parameters.

In another embodiment of the present invention, a data processing apparatus comprises image transform means operable to generate a predicted image from a preceding image, a comparator means operable to compare points in the predicted image with corresponding points in a current image to generate an point error value for each point, a thresholding means operable to identify those points having a point error value that exceeds a point error threshold, and a parameter update means operable to calculate iterative adjustments to image transform parameters so as to reduce a global error between the current image and successive predicted images, whilst excluding those points identified as having a point error value that exceeds a point error threshold from the calculation.

An apparatus so arranged can thus provide means to classify specific video shots by analysis of the image transform parameters so obtained, enabling a user to search for such shots within video footage.

Various other respective aspects and features of the invention are defined in the appended claims. Features from the dependent claims may be combined with features of the independent claims as appropriate and not merely as explicitly set out in the claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is an illustration of a range of motions and actions that can be classified as video shots with respect to an image plane.

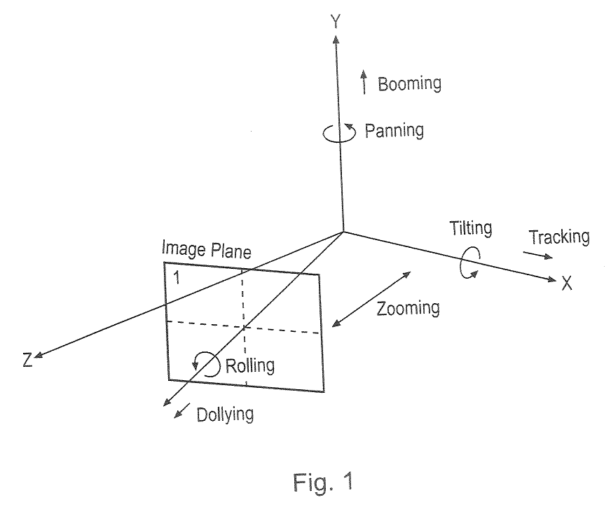

FIG. 2 is an illustration of an image at successive scales in accordance with an embodiment of the present invention.

FIG. 3 is a flow diagram of a method of image transform parameter derivation in accordance with an embodiment of the present invention.

FIG. 4 is an illustration of an error thresholding and identification process in accordance with an embodiment of the present invention.

FIG. 5 is a flow diagram of a method of local motion error mitigation in accordance with an embodiment of the present invention.

FIG. 6 is a flow diagram illustrating the classification of video shots based upon image transform parameters in accordance with an embodiment of the present invention.

FIG. 7 is a block diagram of a data processing apparatus in accordance with an embodiment of the present invention.

FIG. 8 is a block diagram of a video processor in accordance with an embodiment of the present invention.

### DESCRIPTION OF THE PREFERRED EMBODIMENTS

A method of video shot classification and apparatus operable to carry out such classification is disclosed. In the following description, a number of specific details are presented in order to provide a thorough understanding of embodiments of the present invention. It will be apparent, however, to a person skilled in the art that these specific details need not be employed to practice the present invention. Conversely, specific details known to the person skilled in the art are omitted for the purposes of clarity in presenting the embodiments.

In categorising video shots such as panning and zooming, a method of motion estimation is a precursor step. N. Diehl, “Object-oriented motion estimation and segmentation in image sequences”, Signal Processing: Image Communication, 3(1):23-56, 1991 provides such a motion estimation step, and is incorporated herein by reference.

In the above referenced paper (hereinafter ‘Diehl’), for a sequence of images an image transform h(c, T) is used to predict the current image from its preceding image, for the co-ordinate system c. An optimisation technique is then applied to the parameter vector T to update the prediction, so as to generate as close a match as possible between the predicted and actual current image, so updating the image transform parameters in the process.

The resulting update of image transform parameter vector T may then in principle be analysed in a manner similar to the translation function disclosed in WO-A-0046695 (Philips) as noted above, to determine the type of shot it embodies.

Embodiments of the present invention provide a means or method of obtaining the image transform parameter vector T that is comparatively robust to objects moving within the image, so enabling an improved analysis and consequential categorisation of shot.

In Diehl, image transform parameter vector T comprises eight parameters a₁ to a₈, which incorporate rotational and translational motion information to provide a three-dimensional motion model.

To transform between co-ordinate systems c and c′, the translation of a point (x, y) in a preceding image to (x′,y′) in a predicted image is then achieved by using the transform h((x,y),T) where h((x,y),T) is:

$${x}^{′} = \frac{( 1 + {a}_{1} ) x + {a}_{2} y + {a}_{3}}{{a}_{7} x + {a}_{8} y + 1}$$

$${y}^{′} = \frac{{a}_{4} x + ( 1 + {a}_{5} ) y + {a}_{6}}{{a}_{7} x + {a}_{8} y + 1} .$$

The update of T=[a₁, a₂, a₃, a₄, a₅, a₆, a₇, a₈]^{T} will now be described in detail. Without loss of generalisation to other applicable optimisation techniques, the update of T is described with reference to a modified Newton-Raphson algorithm as described in Diehl.

The value of T is updated iteratively by gradient descent of the error surface between the image Ĩₙ₊₁, as predicted by application of T to preceding image Iₙ, with the actual current image Iₙ₊₁.

T is then updated as Tₖ₊₁=−H⁻¹ g(Tₖ), where g(Tₖ) is the error surface gradient and H is the Hessian of the corresponding error function, for as many cycles 1 . . . k . . . K as are necessary to achieve a desired error tolerance. Typically half a dozen cycles may be necessary to update T so as to provide a sufficiently accurate image transform.

The Hessian H is the second derivative of the error function and is calculated as

$$H = E \{ ( \frac{\partial {I}_{n} ( {c}^{′} )}{\partial T} ) {( \frac{\partial {I}_{n} ( {c}^{′} )}{\partial T} )}^{T} \} {\vert}_{T = 0} ,$$

where E is the expectation operator,

$$\frac{\partial {I}_{n} ( {c}^{′} )}{\partial T} = \frac{\partial {I}_{n}}{\partial {c}^{′}} \frac{\partial {c}^{′}}{\partial T} , and \frac{\partial {c}^{′}}{\partial T} = [ \begin{matrix}x & y & 1 & 0 & 0 & 0 & - {x}^{2} & - yx \\ 0 & 0 & 0 & x & y & 1 & - yx & - {y}^{2}\end{matrix} ] .$$

The gradient vector g(Tₖ) is calculated as

$$g ( {T}_{k} ) = E [ ( {I}_{n + 1} - {\hat{I}}_{n + 1} ) {( \frac{\partial {I}_{n} ( {c}^{′} )}{\partial T} )}^{T} ] .$$

For the first iteration for the first predicted frame, the initial value of T is T=[0, 0, 0, 0, 0, 0, 0, 0]^{T}, which corresponds in h(c, T) to a unit multiplication of the current co-ordinate system c with no translation or rotation such that c′=c. Thus, the assumed initial condition is that there is no motion.

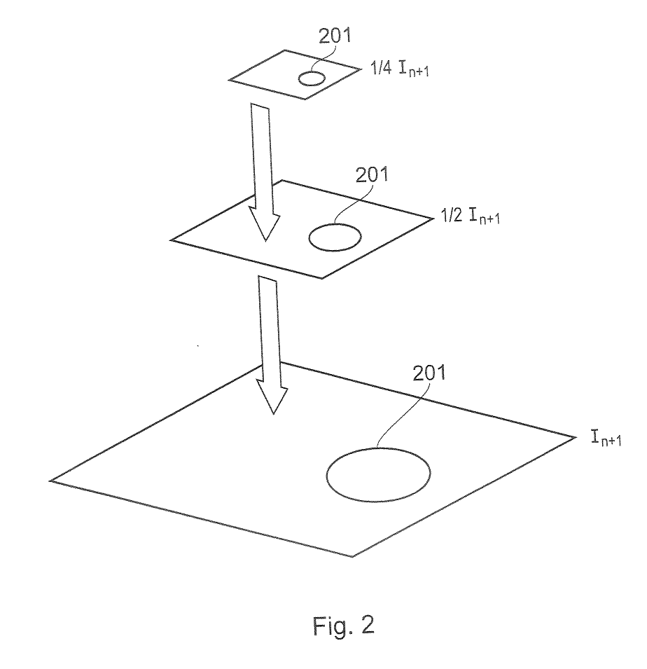

Referring now to FIG. 2, in an embodiment of the present invention, the preceding image Iₙ and the actual current image Iₙ₊, are resampled with 1:4 and 1:2 sampling ratios to provide additional quarter- and half-scale versions of the images.

In conjunction with the original image, three versions of each image are thus available, denoted ¼Iₙ, ½Iₙ, Iₙ for the preceding image and ¼Iₙ₊₁, ½Iₙ₊₁ and Iₙ₊₁ for the current image, respectively. In FIG. 2, ¼Iₙ₊₁, ½Iₙ₊₁ and Iₙ₊₁, are shown in succession, the image portraying an object 201 within part of its field.

Rescaling the images to half and quarter scales progressively reduces the level of detail in the resulting images. This has the advantageous effect of smoothing the error surface generated between the current image and the image predicted by applying T to the preceding image.

Thus the error surface for a quarter-scale image error function J=0.5E[(¼Iₙ₊₁, −h(¼Iₙ,T))²] is smoother than for a full-scale image error function J=0.5E[(Iₙ₊₁−h(Iₙ,T))²]. Consequently, convergence generally takes fewer iterations, and there is less risk of converging to local minima. In addition, the resealed images are much smaller and so considerably less processing is required for each iteration.

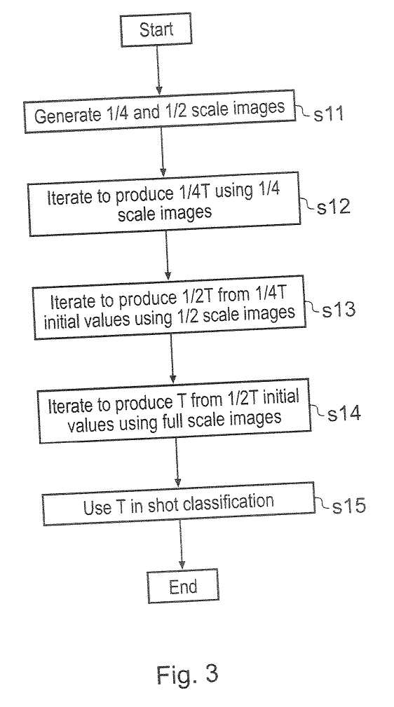

Referring now to FIG. 3, a method of updating parameter vector T comprises resampling, at step s11, the images Iₙ and Iₙ₊₁, to create half and quarter scale image versions. At step s12, using the 1/4 scale images ¼Iₙ and ¼Iₙ₊₁, parameter vector T is updated as described previously until the iterations are terminated when a predetermined threshold value of the error function is reached.

This value of T can therefore be considered a first approximation for the correct value needed to reach the global minimum of the smoothed error surface, and can be denoted ¼T.

At step s13, the process is repeated using the 1/2 scale images ½In and ½Iₙ₊₁, but inheriting the values of ¼T as the initial parameter values of the transform. The parameter values are updated again until the iterations are terminated when a predetermined, lower threshold value of the error function is reached.

Thus ¼T is refined to a second approximation of the correct value needed to reach the global minimum for a less smoothed version of the error surface, having started from close by. This second approximation can be denoted ½T. It will be appreciated that typically fewer iterations will be necessary to perform the refinement of step s13 when compared with step s12.

Finally at step s14, the process is repeated using full scale images Iₙ and Iₙ₊₁, whilst inheriting the values of ½T as initial conditions. The parameter values are updated until the iterations are terminated when a predetermined, even lower threshold value of the error function is reached.

Thus ½T is refined to give a close, final approximation to the correct value for finding the global minimum of the actual error surface with respect to the target image Iₙ₊₁. This final approximation is the parameter vector T that is used for video shot analysis in step s15.

The value of T so obtained can then be used as the initial condition for ¼T when analysing the next image in the footage, assuming approximate continuity of shot between successive frames.

In an alternative embodiment, parameter vector T is updated at each image scale as described previously, but with the iterations terminating when the change in error between successive iterations falls below a predetermined threshold value indicating that the error function is nearing a minimum.

It will be appreciated that several parameters of T, namely a₃ and a₆, are in pixel units. Consequently their values are doubled when inheriting parameter values between steps s12, s13 and s14, and are quartered when using the values of T as the initial ¼T for the next image pair analysis.

It will similarly be appreciated that alternative resealing techniques, such as regional averaging, may be used.

It will also be appreciated that other scaling factors than 1/2 and 1/4 may be employed.

Thus it will be appreciated by a person skilled in the art that references to pixels encompasses comparative points that may correspond to a pixel, or a pixel in a sub-sampled domain (e.g. half scale, quarter scale, etc.), or a block or region of pixels, as appropriate.

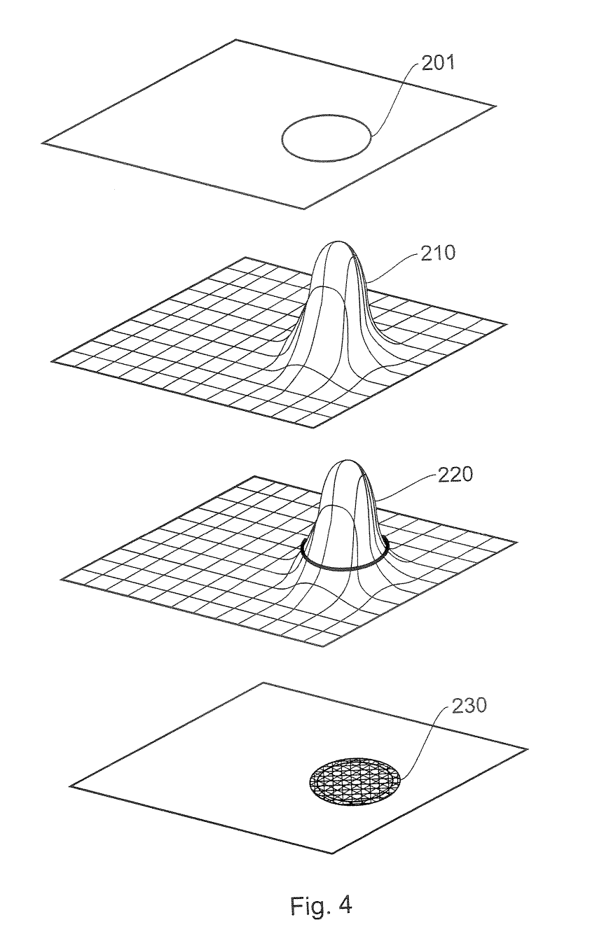

Referring now to FIG. 4, in an embodiment of the present invention the localised motion of objects within the footage under analysis can be mitigated against by a further analysis of the error function values.

The error function J=0.5E[(Iₙ₊₁−h(Iₙ,T)²] operates over all pixels of the image Iₙ₊₁ and the predicted image output by h(Iₙ,T), denoted Ĩₙ₊₁. Thus there is an error value of J_{x,y} for each (x, y) position under comparison in Ĩₙ₊₁. Advantageously, the error value can be taken as indicative of whether a pixel in Iₙ₊₁, illustrates a locally moving object within the image, as it is likely to show a greater error value if the object has moved in a manner contrary to the overall motion of the image, when the pixel is mapped by h(Iₙ,T) and compared with Iₙ₊₁.

Thus, any pixel whose error exceeds a threshold value is defined as belonging to a moving object. The error value J_{x,y} can either be clipped to that threshold value, or omitted entirely from the overall error function J for the predicted image Ĩₙ₊₁.

An illustration of this process is illustrated in FIG. 4, where an image shows the object 201, which is in fact a locally moving object. Comparison between the current and predicted images produces the error values 210, overlaid on the image for exemplary purposes. A threshold 220 is then applied to the error values, and those pixels 230 whose values exceed the threshold 220 are then excluded from further calculations.

In particular, these pixels are then excluded from computation of the Hessian, such

$$H = E \{ ( \frac{\partial {I}_{n}^{′} ( {c}^{′} )}{\partial T} ) {( \frac{\partial {I}_{n}^{′} ( {c}^{′} )}{\partial T} )}^{T} \} {\vert}_{T = 0} ,$$

where I′ₙ is the preceding image Iₙ, excluding those pixels corresponding to those whose error that exceed the error value threshold during comparison of the current and predicted image. In a similar fashion, these pixels are also excluded from calculation of the gradient vector g(Tₖ.

Typically the pixels excluded will exceed the number of pixels representing the object, as prediction errors will also occur for those parts of the background newly revealed by virtue of the object motion between the successive frames in the pair. Thus the pixels excluded will typically comprise the set of pixels illustrating the moving object in both the preceding and current frames.

Advantageously therefore, the image transform parameter values of T are updated substantially in the absence of motion information from locally moving objects in the images, resulting in a more accurate representation of the actual video shot.

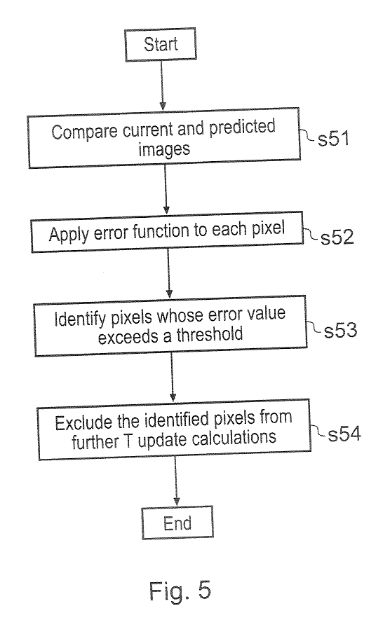

Referring to FIG. 5, in an embodiment of the present invention T may therefore be updated according to the following steps; In step s51, the current image and a predicted image dependent upon image transform parameter vector T are compared. In step s52, an error function is applied on a pixel-by-pixel basis. In step s53, those pixels whose error exceeds a threshold value are identified for exclusion, and in step s54, subsequent calculation steps for the update of T exclude those identified pixels in corresponding images.

A person skilled in the art will appreciate that numerous variations are possible. For example, the initial conditions for T for the first iteration of the first image pair under analysis assume no motion, as noted previously. Thus in principle every pixel could show significant errors if these first images are actually part of a moving video shot. Therefore, the elimination of pixels exceeding an error value may be suspended either for a fixed number of frames, or until the error function J falls below a given threshold, so indicating that T is now approximately accurate.

In another embodiment, the pixel error threshold can be dynamically set relative to the average pixel error. By setting the threshold to be proportionately greater than the average pixel error, it advantageously becomes more sensitive to local motion as T becomes more accurate.

In a further embodiment, a combination could be used wherein the threshold is dynamically set, up to a certain absolute level.

Preferably, the choice of excluded pixels is fixed during a given set of update iterations for T; reassessing the pixels for each iteration not only adds computational load, but adds noise to the error surface as the reassessed image may change slightly with each iteration.

However, in combination with rescaling of the images to quarter and half scales, the excluded pixels may either be mapped from quarter to half, and half to full scale images for steps s13 and s14, or in an alternative embodiment are reassessed at the start of steps s13 and s14. Reassessment of the point errors on the basis of an improved estimate of T enables improved discrimination of the background and locally moving objects for subsequent iterations of T.

Furthermore, in this embodiment the threshold (either absolute or in comparison with the mean error) at which the point error is defined as representing a moving object can be reduced with successive image scales.

Thus, for example, excluded pixels may be initially determined for a quarter scale image, and omitted during the remaining determination of ¼T. Then, either the pixels may be re-assessed for the half-scale mappings, using a predicted image based on the values inherited from ¼T, or a re-scaled mapping of the currently excluded pixels from the quarter scaled image may be applied to the half-scaled image directly. In this latter case, optionally the pixels may be reassessed again if the values of T change significantly upon further iteration with the new scale image. The above options may be considered again for the change from half- to full-scale images.

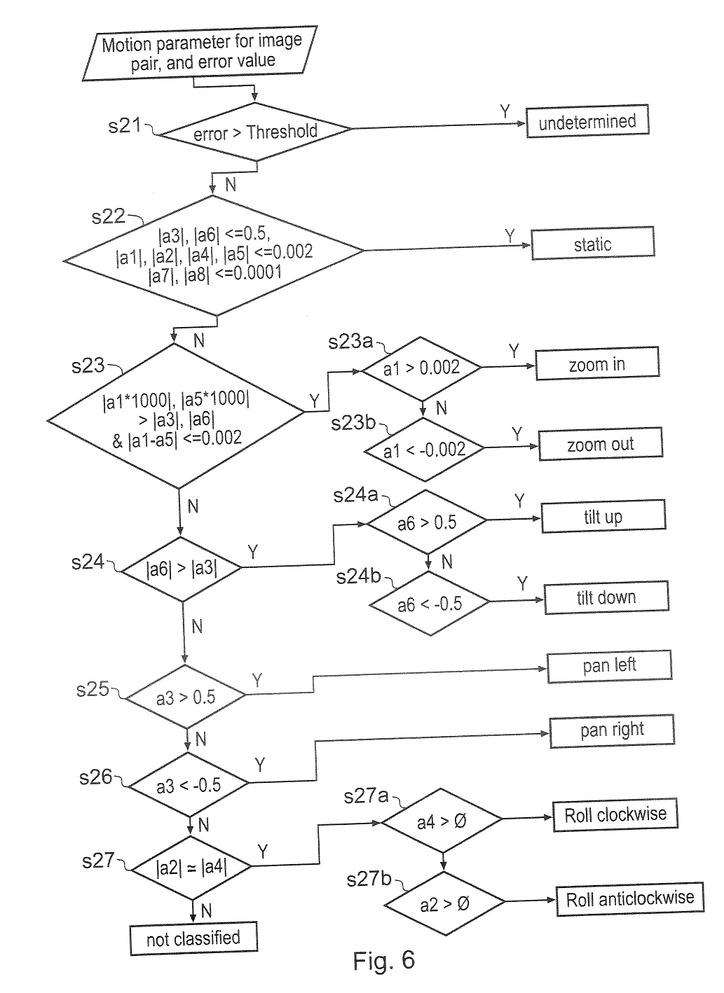

Referring now to FIG. 6, once the final parameter values T have been obtained for a preceding/current image pair, a shot classification is performed based upon the parameter values in conjunction with the final error value J.

Although in FIG. 6 actual threshold values are given, it will be appreciated that these are merely examples, and that the general principle is to base a categorisation on the levels of various parameters T.

In step s21, if the final error value J exceeds a confidence threshold, then T is considered an unreliable indicator of the shot, and an ‘undetermined’ classification is given to the frame.

In step s22, if the absolute parameter values are all below respective threshold values, the shot is classified as ‘static’.

In step s23, if a₁, a₃ and a₅ satisfy the criteria shown in FIG. 6, then in substep s23a, if a₁, exceeds a given positive threshold, the shot is classified as a zoom in, whilst in substep s23b, if a₁ is less than a given negative threshold, the shot is classified as a zoom out.

Similarly in step s24, if a₃ and a₆ satisfy the criterion shown in FIG. 6, then in substep s24a, if a₆ exceeds a given positive threshold, the shot is classified as a tilt up, whilst in substep s24b, if a₆ is less than a given negative threshold, the shot is classified as a tilt down.

In step s25, if a₃ exceeds a given positive threshold, the shot is classified as a pan left, whilst in step s26, if a₃ is less than a given negative threshold, the shot is classified as a pan right.

In step s27, if a₂ and a₄ have approximately the same magnitude, then in substep s27a, if a₄ is positive, the shot is classified as rolling clockwise, whilst in substep s27b if a₂ is positive, the shot is classified as rolling anticlockwise. If the result of step s27 is in the negative, the shot is not classified.
It will be appreciated that in the above classifications for a given frame pair;
i. tracking will be classified as panning;
ii. booming will be classified as tilting, and;
iii. dollying will be classified as zooming.

It will be appreciated that, optionally, only a subset of the above shot classifications may be tested for.

It will also be appreciated that the angle of roll between successive images (and cumulatively) can be derived using a₂ and a₄, and can provide further shot classification criteria based on shot angle.

The above process thus classifies the shot for a given frame pair. The shot overall is then classified in accordance the predominant classification, as determined above, for the successive image pairs within the duration of the shot. The duration of the shot may be defined in terms of a time interval, or between successive I-frames, or by a global threshold value indicating a change in image content (either derived from J above or separately), or from camera metadata if available. If there is no clearly predominant classification, a wide distribution of classifications, or a large number of opposing panning or tilting motions, then an overall shot classification of ‘camera shake’ can also be given.

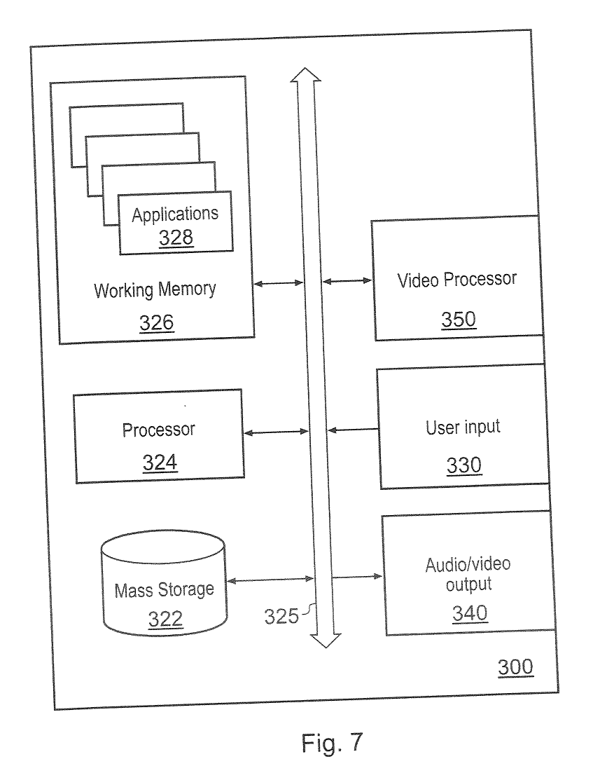

Referring now to FIG. 7, a data processing apparatus 300 in accordance with an embodiment of the present invention is schematically illustrated. The data processing apparatus 300 comprises a processor 324 operable to execute machine code instructions stored in a working memory 326 and/or retrievable from a mass storage device 322. By means of a general-purpose bus 325, user operable input devices 330 are in communication with the processor 324. The user operable input devices 330 comprise, in this example, a keyboard and a touchpad, but could include a mouse or other pointing device, a contact sensitive surface on a display unit of the device, a writing tablet, speech recognition means, haptic or tactile input means, video input means or any other means by which a user input action can be interpreted and converted into data signals.

In the data processing apparatus 300, the working memory 326 stores user applications 328 which, when executed by the processor 324, cause the establishment of a user interface to enable communication of data to and from a user. The applications 328 thus establish general purpose or specific computer implemented utilities and facilities that might habitually be used by a user.

Audio/video communication devices 340 are further connected to the general-purpose bus 325, for the output of information to a user. Audio/video communication devices 340 include a visual display, but can also include any other device capable of presenting information to a user, as well as optionally video input and acquisition means.

A video processor 350 is also connected to the general-purpose bus 325. By means of the video processor, the data processing apparatus is capable of implementing in operation the method of video shot classification, as described previously.

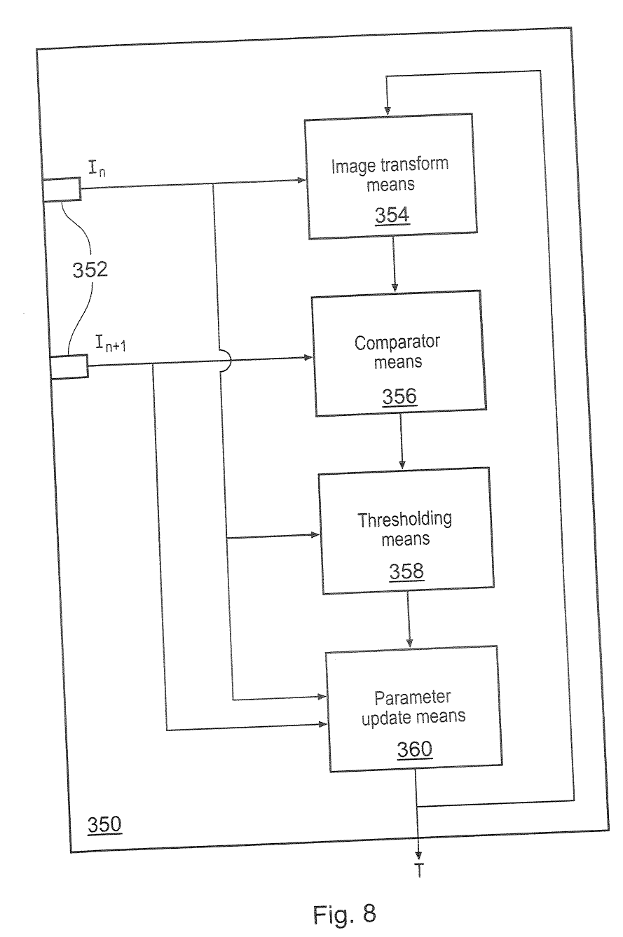

Referring now to FIG. 8, specifically the video processor 350 comprises input means 352, to receive image pair Iₙ and Iₙ₊₁. Image Iₙ is passed to image transform means 354, which is operable to apply h(Iₙ,T) and output Ĩₙ₊₁. This output and Iₙ₊₁ are input to comparator means 356, which generates error function J. The resultant error values and image Iₙ are input to thresholding means 358, in which pixels of In corresponding to error values exceeding a threshold value are identified for exclusion. The exclusion information and images Iₙ₊₁, Ĩₙ₊₁ and Iₙ are input to parameter update means 360, which iterates values of image transform parameter vector T, excluding the identified pixels from the update calculations. The updated vector T is passed back to the image transform means and also output to general bus 325.

In operation, processor 324, under instruction from one or more applications 328 in working memory 326, accesses pairs of images from mass storage 322 and sends them to video processor 350. Subsequently, and updated version of image transform parameter vector T is received from the video processor 350 by the processor 324, and is used to classify the shot under instruction from one or more applications 328 in working memory 326.

In an embodiment of the present invention, processor 324, under instruction from one or more applications 328 in working memory 326, re-scales images accessed from mass storage 322. In this case, the parameter vector T returned from the video processor will correspond with ¼T, ½T or T as appropriate.

The data processing apparatus may form all or part of a video editing system or video archival system, or a combination of the two. Mass storage 322 may be local to the data processing apparatus, or may for example be a server on a network.

It will be appreciated that in embodiments of the present invention, the video processor 350 and the various elements it comprises may be located either within the data processing apparatus 300, or within the video processor 350, or distributed between the two, in any suitable manner. For example, video processor 350 may take the form of a removable PCMCIA or PCI card. In other examples, applications 328 may comprise a proportion of the elements described in relation to the video processor 350, for example for thresholding of the error values. Conversely, the video processor 350 may further comprise means to re-scale images itself.

Thus the present invention may be implemented in any suitable manner to provide suitable apparatus or operation. In particular, it may consist of a single discrete entity, a single discrete entity such as a PCMCIA card added to a conventional host device such as a general purpose computer, multiple entities added to a conventional host device, or may be formed by adapting existing parts of a conventional host device, such as by software reconfiguration, e.g. of applications 328 in working memory 326. Alternatively, a combination of additional and adapted entities may be envisaged. For example, image transformation and comparison could be performed by the video processor 350, whilst thresholding and parameter update is performed by the central processor 324 under instruction from one or more applications 328. Alternatively, the central processor 324 under instruction from one or more applications 328 could perform all the functions of the video processor 350.

Thus adapting existing parts of a conventional host device may comprise for example reprogramming of one or more processors therein. As such the required adaptation may be implemented in the form of a computer program product comprising processor-implementable instructions stored on a data carrier such as a floppy disk, optical disk, hard disk, PROM, RAM, flash memory or any combination of these or other storage media, or transmitted via data signals on a network such as an Ethernet, a wireless network, the internet, or any combination of these or other networks.

A person skilled in the art will appreciate that in addition to alternative optimisation techniques, for example as detailed in Diehl, alternative error functions may be used as a basis for the determination of pixels corresponding to locally moving objects. In addition, alternative parameter based motion models are envisaged, such as, for example, those listed in Diehl. As such, different forms of parameter vector may be obtained and used as a basis for video shot classification whilst in accordance with embodiments of the present invention.

A person skilled in the art will appreciate that embodiments of the present invention may confer some or all of the following advantages;
i. a video shot classification technique providing characterisation of successive images robust to local motion within the images due to the omission of local motion pixels;
ii. robust parameter iteration due to use of reduced scale images;
iii. reduced computational overhead during parameter iteration due to use of reduced scale images, and;
iv. reduced computational overhead during parameter iteration due to the omission of local motion pixels.

Although illustrative embodiments of the invention have been described in detail herein with respect to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A method of classifying a video shot, comprising the steps of:
predicting an image from a preceding image using a parameter based image transform;
comparing points in the predicted image with corresponding points in a current image to generate an point error value for each point;
identifying those points having a point error value that exceeds a point error threshold, and;
for corresponding points on images used as inputs to subsequent calculations that update the image transform parameters,
excluding from said calculations the points so identified.

2. A method according to claim 1, in which the image transform parameters are updated by:
iterating a gradient descent method that alters the image transform parameter values;
generating a global error value based upon the current image and an image predicted from the preceding image in accordance with the current iteration of the image transform parameter values, and;
terminating the iteration when any or all of the following criteria are met:
i. the global error value falls below a global error threshold, and;
ii. the change in global error value between successive iterations falls below a convergence threshold.

3. A method according to claim 1, further comprising the steps of:
using one or more reduced-scale and full-scale versions of the preceding and current images in successive updates of the image transform parameters, and;
initially using updated image transform parameters derived at a more-reduced scale as the basis for image prediction at a less-reduced scale.

4. A method according to claim 3, in which quarter, half and full-scale images are used.

5. A method according to claim 3, in which a global error threshold used to terminate a gradient descent method is dependent upon image scale.

6. A method according to claim 1, in which initially identified points are not excluded from said calculations until any or all of the following criteria are met:
i. a predefined number of frame pairs has been analysed, and;
ii. a global error for the compared images is below a given initiation threshold.

7. A method according to claim 1, in which the point error threshold is proportionately above a mean point error value.

8. A method according to claim 1, in which the point error threshold is dependent upon image scale.

9. A method according to claim 1, in which said subsequent calculations comprise any or all of:
i. obtaining the global error between the current image and a predicted image;
ii. obtaining the gradient of an error surface dependent upon image transform parameters, and;
iii. obtaining the Hessian of an error function used to obtain an error surface dependent upon image transform parameters.

10. A method according to claim 1, in which an overall shot is classified according to the prediminant image pair shot classification to occur within a section of video comprising the overall shot.

11. A method according to claim 10, in which an overall shot classification is selected from a group of shots comprising any or all of.
i. pan;
ii. tilt;
iii. roll, and;
iv. zoom.

12. A method according to claim 10, in which a classification of ‘camera shake’ is given where any or all of the following criteria are met:
i. there is no clearly predominant image pair shot classification within the overall shot that is selectable;
ii. there is a wide distribution of different classification types, and;
iii. there are classifications indicative of rapid changes of direction within the overall shot.

13. A data processing apparatus comprising:
image transform means operable to generate a predicted image from a preceding image by a parameter based transform;
comparator means operable to compare points in the predicted image with corresponding points in a current image to generate an point error value for each point;
thresholding means operable to identify those points having a point error value that exceeds a point error threshold, and;
parameter update means operable to calculate iterative adjustments to image transform parameters so as to reduce a global error between the current image and successive predicted images, whilst excluding from the calculation those points identified as having a point error value that exceeds a point error threshold.

14. A data processing apparatus according to claim 13, in which the image transform means, comparator means, thresholding means and parameter update means are operable to perform successive updates of the image transform parameters based upon one or more reduced-scale and full scale versions of the preceding and current images.

15. A data processing apparatus according to claim 13, in which quarter, half and full-scale images are used.

16. A video editing system comprising the data processing apparatus of claim 13.

17. A video editing system according to claim 16 operable to carry out the method of claim 1.

18. A video archival system comprising the data processing apparatus of claim 13.

19. A video archival system according to claim 18 operable to carry out the method of claim 1.

20. A data carrier comprising computer readable instructions that, when loaded into a computer, cause the computer to carry out the method of claim 1.

21. A data carrier comprising computer readable instructions that, when loaded into a computer, cause the computer to operate as a data processing apparatus according to claim 13.

22. A data signal comprising computer readable instructions that, when received by a computer, cause the computer to carry out the method of claim 1.

23. A data signal comprising computer readable instructions that, when received by a computer, cause the computer to operate as a data processing apparatus according to claim 13.

24. Computer readable instructions that, when received by a computer, cause the computer to carry out the method of claim 1.

25. Computer readable instructions that, when received by a computer, cause the computer to operate as a data processing apparatus according to claim 13.

26. A data processing apparatus comprising:
image transforming logic operable to generate a predicted image from a preceding image by a parameter based transform;
a comparator operable to compare points in the predicted image with corresponding points in a current image to generate an point error value for each point;
thresholding logic operable to identify those points having a point error value that exceeds a point error threshold, and;
parameter updating logic operable to calculate iterative adjustments to image transform parameters so as to reduce a global error between the current image and successive predicted images, whilst excluding from the calculation those points identified as having a point error value that exceeds a point error threshold.
